(19) United States
(12) Patent Application Publication
(10) Pub. No.: US 2018/0240353 A1
(43) Pub. Date: Aug. 23, 2018

(54) VIRTUAL AND AUGMENTED REALITY BASED TRAINING OF INHALER TECHNIQUE

(71) Applicant: ROUNDGLASS LLC, Bellevue, WA (US)

(72) Inventors: Vijaya Kumar Bhuttar, Redmond, WA (US); Dmitrii Antonenko, Minsk (BY); Krishnamoorthy Seetharaman, Redmond, WA (US)

(21) Appl. No.: 15/932,265

(22) Filed: Feb. 16, 2018

Related U.S. Application Data
(60) Provisional application No. 62/460,041, filed on Feb. 16, 2017.

(51) Int. Cl. G09B 9/00; H04N 13/332; G06T 19/00; G06F 3/01; G10L 25/48; H04R 1/08

(52) U.S. Cl. CPC G09B 9/00; H04N 13/332; H04R 1/08; G06F 3/012; G10L 25/48; G06T 19/006

(57) ABSTRACT

An apparatus includes a viewer device wearable on the head of a user and including a display. The processor is configured to generate a signal prompting the user to exhale and determine whether audio signals corresponding to the sound captured by a microphone of the user exhaling matches a first audio profile. If the audio signals match the first audio profile, the processor determines whether position signals indicating the spatial orientation of the viewer device matches an orientation profile. If the position signals do not match the orientation profile, the processor generates a directional indicator to indicate to the user the direction in which the user should move the head so that the position signals will match the orientation profile. If the position signals match the orientation profile, the processor generates a signal prompting the user to inhale and determines whether audio signals corresponding to the sound captured by the microphone of the user inhaling matches a second audio profile.

### PRIORITY CLAIM

This Application claims the benefit of U.S. Provisional Application No. 62/460,041 filed Feb. 16, 2017, which is hereby incorporated by reference in its entirety as if fully set forth herein.

### BACKGROUND

Inhalers are small, handheld devices that deliver a puff of medicine into the airways. There are three basic types: metered-dose inhalers (MDIs), dry powder inhalers (DPIs), and soft mist inhalers (SMI). Inhalers are used in the treatment of Asthma and COPD (Chronic Obstructive Pulmonary Disease). Incorrect inhaler technique reduces the impact of the drugs delivered using an inhaler and also causes side-effects.

Based on the following paper published in the American Thoracic Society's (ATS) website (http://www.thoracic.org/about/newsroom/press-releases/resources/teaching-rescue-inhaler-technique-final.pdf), the cost of inhaler misuse accounts for $5-7 billion of the approximately $25 billion spent annually on inhalers. Doctors and other medical professionals are expected to assess and train patients who use inhalers on correct inhaler technique on every encounter. However, doctors and medical professionals are not always able to spend the necessary time with patients assessing and training patients on correct inhaler technique.

### BRIEF DESCRIPTION OF THE DRAWING FIGURES

FIG. 1 is a block diagram of a system according to an embodiment of the present invention;

FIG. 2 is a schematic and flow diagram illustrating components and functionality according to an embodiment of the present invention;

FIG. 3 illustrates a breathe-out sound pattern viewable by a patient in a display according to an embodiment of the present invention;

FIG. 4 illustrates a virtual-reality or augmented-reality directional indicator according to an embodiment of the present invention; and

FIG. 5 illustrates a breathe-out sound pattern viewable by a patient in a display according to an embodiment of the present invention.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the present invention may comprise or utilize a special-purpose or general-purpose computer including computer hardware, such as, for example, one or more processors and system memory, as discussed in greater detail below. Embodiments within the scope of the present invention also include physical and other computer-readable media for carrying or storing computer-executable instructions or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the invention. The computer executable instructions may be, for example, binaries, intermediate format instructions such as assembly language, or even source code.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment of the invention helps assess and train patients on correct inhaler technique with minimal time and effort required from doctors and other healthcare professionals. Thus, an embodiment will improve the productivity of doctors and other healthcare professionals in assessing and training patients on correct inhaler technique.

An embodiment will also result in better health outcomes for patients that use inhaler therapy by:

Increasing the frequency of assessment and training of correct inhaler technique;

Reducing any variance in the quality of manual assessment and training, thereby improving the reliability of assessment and training;

Better patient health outcomes will result in financial gain for the patients, healthcare providers, health insurance companies and employers.

The commercial application of an embodiment will involve providing the correct inhaler technique assessment and training to patients at different settings such as doctors' offices, clinics, hospitals (outpatient and inpatient), urgent care centers, emergency rooms, labs, patients' workplaces and community centers.

An embodiment makes inhaler technique assessment and training for patients easy to administer and improves productivity for healthcare professionals and health outcomes by improving the reliability, consistency and effectiveness of the assessment and training.

An embodiment may include a virtual-reality (VR) or augmented-reality (AR) viewer headset, a processing device, such as a smartphone, and/or software components and content installed on the processing device. For purposes of brevity, all discussions throughout the entirety of this document of VR should be understood to likewise apply to one or more alternative embodiments including AR.

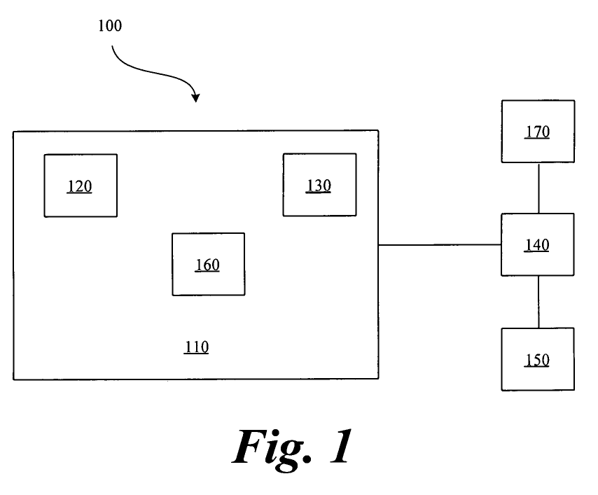

FIG. 1 illustrates a system 100 according to an embodiment of the invention. System 100 includes a virtual-reality or augmented-reality viewer device 110 wearable on the head of a user and including a display 120. Viewer device 110 further includes at least one sensor element assembly 130 serving to determine the three-dimensional orientation and motion of the viewer device. Sensor element assembly 130 may include one or more of, for example, accelerometers, magnetometers, and gyroscopes. Viewer device 110 includes, or is otherwise in communication with, a processor 140. Additionally, system 100 may include a microphone 150 and a speaker 160 in communication with processor 140. In an embodiment, speaker 160 is integrated into viewer device 110. As will be discussed in greater detail below, system 100 further includes a handheld control 170 that is coupled to the processor 140. In an embodiment, microphone 150 and processor 140 may be integrated into a single device such as a conventional smartphone, for example, having cellular and/or Wi-Fi communication capability.

In an embodiment, the processor 140 is configured to receive data identifying an inhaler of a set of inhalers of multiple types. For example, the process according to an embodiment begins with a doctor, healthcare professional or a trained educator initiating an assessment and training program in the system 100 after entering patient identification information and selecting the inhaler type, patient's preferred language of training and patient's preferred language of training environment (for example, virtual environments like mountains or forest or oceans may make the training environment more immersive for the patients) that the patient/user has been prescribed. Multiple training modules corresponding to multiple different inhaler types may be stored in and retrievable by processor 140 from a database.

In an embodiment, system 100 displays introductory messages educating the patient on the scale and impact of incorrect inhaler technique, and explains how the assessment and training will function. System 100 also plays a video demonstration of correct inhaler technique for the selected inhaler type. The instructions and the video are delivered by the viewer device 110 on the display 120.

Correct inhaler technique requires the patient to breathe the air out of their lungs completely so the lungs can effectively receive the medication inhaled using the inhaler. As such, once the training module corresponding and appropriate to the selected inhaler has been selected and received by the processor 140, the processor generates a signal to one or more of the display 120 and speaker 160 prompting the user to exhale. In varying embodiments, microphone 150 will be placed or otherwise positioned sufficiently close to the user's mouth and nose such that sound waves associated with the exhale are captured by the microphone.

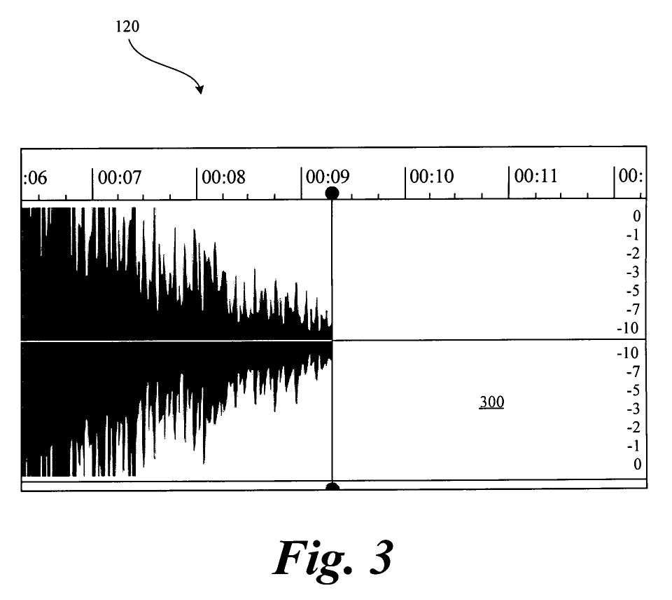

In an embodiment, processor 140 determines whether a set of exhale audio signals received from the microphone and corresponding to the sound captured by the microphone of the user exhaling matches a first predetermined audio profile. Alternatively, a processor (not shown) that is cloud-based or otherwise a part of a wide-area network determines whether a set of exhale audio signals received from the microphone and corresponding to the sound captured by the microphone of the user exhaling matches a first predetermined audio profile. For example, based on the exhale sound pattern and duration, the processor 140 recognizes if the patient has completely expelled the air out of their lungs. One such breathe-out sound pattern 300 is illustrated in FIG. 3 as an example, and is viewable by the patient in the viewer device 110 on the display 120. Using an audio profile, such as a combination of the duration and the pattern of the sound wave, the processor 140 determines if the pattern satisfies a predetermined correct “Breathe Out” technique. System 100 continues providing performance feedback to the patient and requires the patient to repeat this technique until the patient has demonstrated the proper technique. System 100 may require the patient to successfully perform this technique before proceeding to the next step in the training.

One of the key requirements in inhaler technique is to keep the head straight or otherwise correctly positioned while inhaling the medication using an inhaler. As such, in an embodiment, if the set of exhale audio signals matches the first predetermined audio profile, processor 140 determines whether a set of position signals received from the sensor element assembly 130 and indicating the spatial orientation of the viewer device 110 matches a predetermined orientation profile based on data identifying the inhaler. For example, based on the position of the viewer device 110 as indicated by the sensor element assembly 130, processor 140 determines if the viewer device, and consequently the patient's head, is correctly positioned according to a stored head-orientation profile associated with the applicable inhaler type.

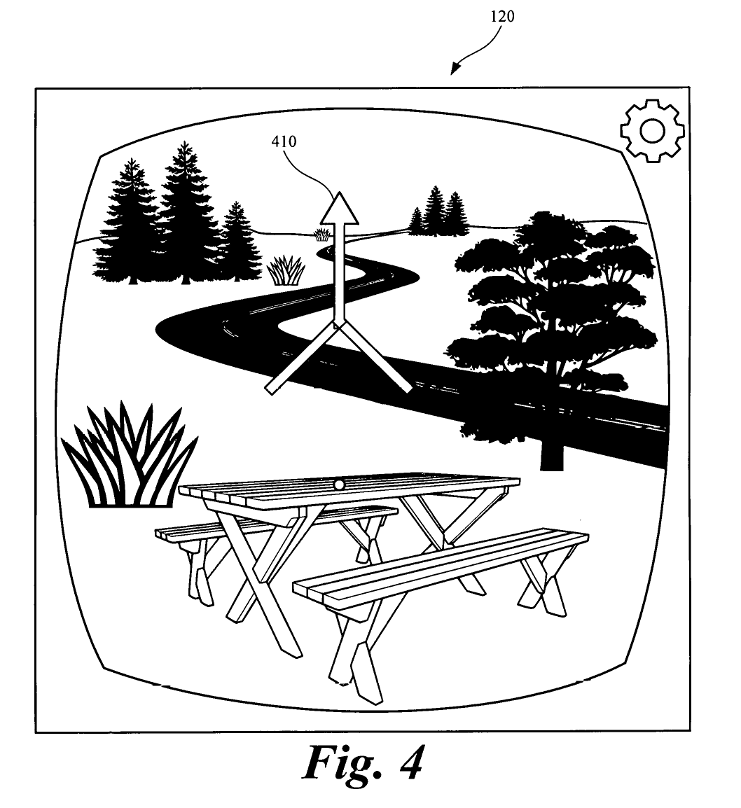

In an embodiment, if the set of position signals does not match the predetermined orientation profile, processor 140 generates at least one directional indicator to the display 120 to indicate to the user the direction in which the user should move the head so that the set of position signals will match the predetermined orientation profile. As best illustrated in FIG. 4, if the user's head is not properly oriented for inhaler use, display 120 provides instructional feedback to the patient as to the direction in which their head should be moved. For example, the white arrow 410 is instructing the patient to lift his/her head up to achieve proper alignment. Similarly, system 100 may provide down, right, left and angular arrows to display 120 to instruct the patient in movement needed to achieve proper alignment. System 100 continues providing performance feedback to the patient and requires the patient to repeat this technique until the patient has demonstrated the proper technique. System 100 may require the patient to successfully perform this technique before proceeding to the next step in the training.

With most common inhalers, correct inhaler technique requires the patient to breathe in at the same time as pressing the dispensing mechanism associated with the inhaler. As such, and in an embodiment, if the set of position signals matches the predetermined orientation profile, processor 140 generates one or more signals to one or more of the display 120 and speaker 160 prompting the user to inhale and activate the handheld control 170 at the same time that the user inhales. Processor 140 further determines whether a set of inhale audio signals received from the microphone 150 and corresponding to the sound of the user inhaling matches a second predetermined audio profile. For example, handheld control 170 may comprise a button/switch in communication with processor 140 to simulate the pressing by the patient of the dispensing mechanism. The handheld control 170 sends a signal to the processor 140 at the moment pressed. Processor 140 compares the timing of the button press with the timing of the beginning of the patient breathing in based on a breathe-in sound pattern to determine if there was a timing mistake made by the patient.

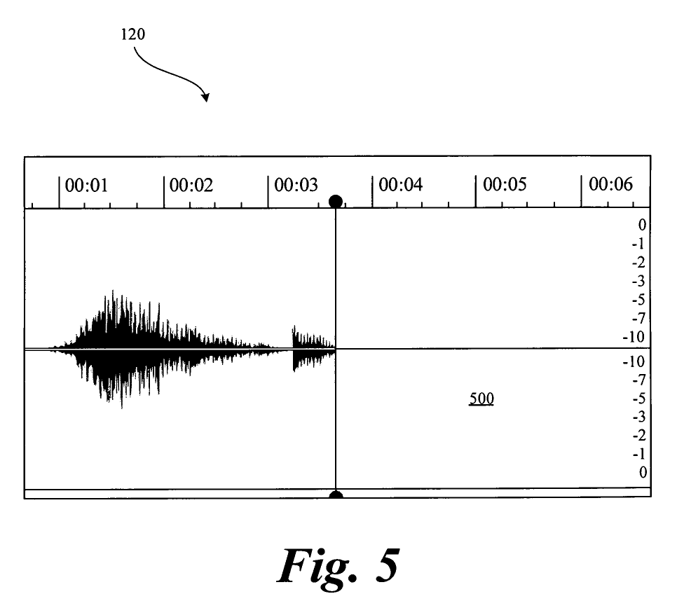

One such breathe-in sound pattern 500 is illustrated in FIG. 5 as an example, and is viewable by the patient in the viewer device 110 on the display 120. Using an audio profile, such as a combination of the duration and the pattern of the sound wave, the processor 140 determines if the pattern satisfies a predetermined correct “Breathe in” technique. System 100 continues providing performance feedback to the patient and requires the patient to repeat this technique until the patient has demonstrated the proper technique. System 100 may require the patient to successfully perform this technique before confirming that the training has been successfully completed.

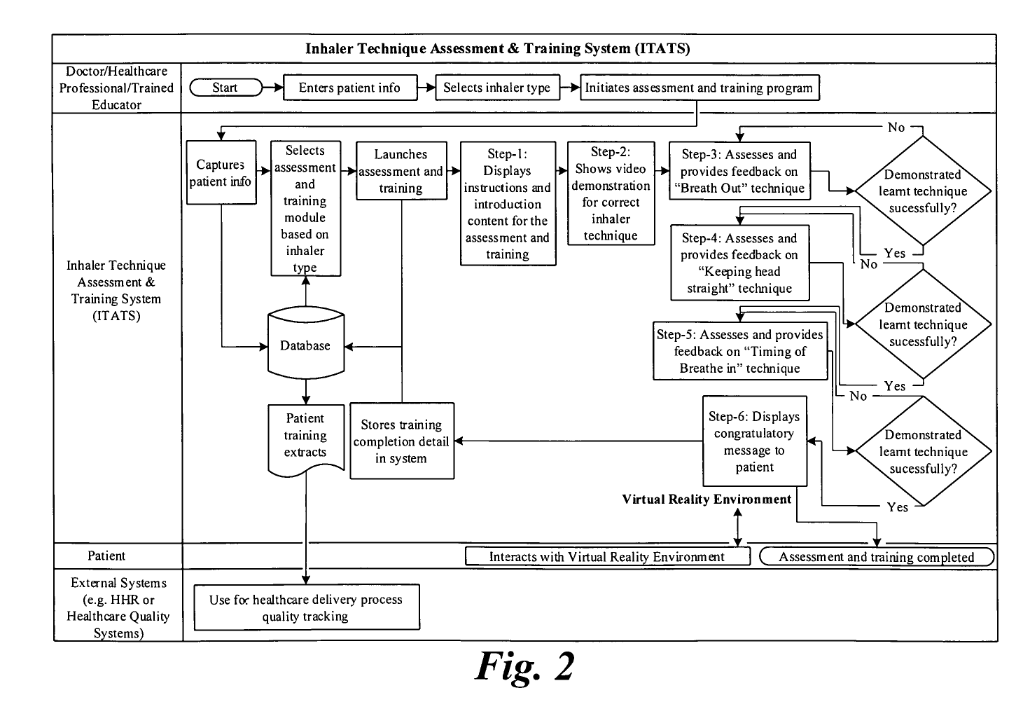

In an embodiment, system 100 stores in a database information about each training session, including the number of attempts for each step, for future reference. As illustrated in FIG. 2, patient details and training details are transmitted over the World Wide Web and stored in a database for creating extracts that can be pushed into external systems such as Electronic Health Records (EHRs) or healthcare quality systems (like Healthcare Effectiveness Data and Information Set (HEDIS) and National Committee for Quality Assurance (NCQA)).

System 100 may also extract the appropriate assessment and training module based on the inhaler type that the patient is prescribed. It is possible that the appropriate training module can also be customized further based on the patient demographics for effectiveness.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus, comprising:
a viewer device including at least one sensor element, a processor and at least one output element including a display, the viewer device being wearable on the head of a user; and
a microphone in communication with the processor,
wherein the processor is configured to:
generate a signal to the at least one output element prompting the user to exhale,
determine whether a set of exhale audio signals received from the microphone and corresponding to the sound captured by the microphone of the user exhaling matches a first predetermined audio profile,
if the set of exhale audio signals matches the first predetermined audio profile, determine whether a set of position signals received from the at least one sensor element and indicating the spatial orientation of the viewer device matches a predetermined orientation profile,
if the set of position signals does not match the predetermined orientation profile, generate at least one directional indicator to the display to indicate to the user the direction in which the user should move the head so that the set of position signals will match the predetermined orientation profile,
if the set of position signals matches the predetermined orientation profile, generate a signal to the at least one output element prompting the user to inhale, and
determine whether a set of inhale audio signals received from the microphone and corresponding to the sound captured by the microphone of the user inhaling matches a second predetermined audio profile.

2. The apparatus of claim 1, wherein:
the processor is further configured to receive data identifying an inhaler of a set of inhalers of multiple types; and
the predetermined orientation profile is based on the data identifying the inhaler.

3. The apparatus of claim 1, further comprising a handheld control that is coupled to the processor, wherein the processor is further configured to generate a signal to the at least one output element prompting the user to activate the handheld control at the same time that the user inhales.

4. The apparatus of claim 1, wherein the at least one output element includes a speaker.

5. The apparatus of claim 1, wherein if the set of exhale audio signals does not match the first predetermined audio profile, the processor is further configured to generate a signal to the at least one output element prompting the user to exhale.

6. The apparatus of claim 1, wherein if the set of inhale audio signals does not match the second predetermined audio profile, the processor is further configured to generate a signal to the at least one output element prompting the user to inhale.

7. An apparatus, comprising:
a viewer device including at least one sensor element and at least one output element including a display, the viewer device being wearable on the head of a user; and
at least one computer-readable medium on which are stored instructions that, when executed by at least one processor coupled to a microphone, enable the at least one processor to perform a set of actions comprising:
generating a signal to the at least one output element prompting the user to exhale,
determining whether a set of exhale audio signals received from the microphone and corresponding to the sound captured by the microphone of the user exhaling matches a first predetermined audio profile,
if the set of exhale audio signals matches the first predetermined audio profile, determining whether a set of position signals received from the at least one sensor element and indicating the spatial orientation of the viewer device matches a predetermined orientation profile,
if the set of position signals does not match the predetermined orientation profile, generating at least one directional indicator to the display to indicate to the user the direction in which the user should move the head so that the set of position signals will match the predetermined orientation profile,
if the set of position signals matches the predetermined orientation profile, generating a signal to the at least one output element prompting the user to inhale, and
determining whether a set of inhale audio signals received from the microphone and corresponding to the sound of the user inhaling matches a second predetermined audio profile.

8. The apparatus of claim 7, wherein:
the set of actions further comprises receiving data identifying an inhaler of a set of inhalers of multiple types; and
the predetermined orientation profile is based on the data identifying the inhaler.

9. The apparatus of claim 7, further comprising a handheld control that is coupled to the processor, wherein the set of actions further comprises generating a signal to the at least one output element prompting the user to activate the handheld control at the same time that the user inhales.

10. The apparatus of claim 7, wherein the at least one output element includes a speaker.

11. The apparatus of claim 7, wherein the set of actions further comprises generating a signal to the at least one output element prompting the user to exhale if the set of exhale audio signals does not match the first predetermined audio profile.

12. The apparatus of claim 7, wherein the set of actions further comprises generating a signal to the at least one output element prompting the user to inhale if the set of inhale audio signals does not match the second predetermined audio profile.

13. An apparatus including at least one computer-readable medium on which are stored instructions that, when executed by at least one processor in communication with a microphone, enable the at least one processor to perform a set of actions comprising:
generating, to at least one output element of a viewer device wearable on the head of a user, a signal prompting the user to exhale, the viewer device including at least one sensor element, the at least one output element including a display;
determining whether a set of exhale audio signals received from the microphone and corresponding to the sound captured by the microphone of the user exhaling matches a first predetermined audio profile,
if the set of exhale audio signals matches the first predetermined audio profile, determining whether a set of position signals received from the at least one sensor element and indicating the spatial orientation of the viewer device matches a predetermined orientation profile,
if the set of position signals does not match the predetermined orientation profile, generating at least one directional indicator to the display to indicate to the user the direction in which the user should move the head so that the set of position signals will match the predetermined orientation profile,
if the set of position signals matches the predetermined orientation profile, generating a signal to the at least one output element prompting the user to inhale, and
determining whether a set of inhale audio signals received from the microphone and corresponding to the sound of the user inhaling matches a second predetermined audio profile.

14. The apparatus of claim 13, wherein:
the set of actions further comprises receiving data identifying an inhaler of a set of inhalers of multiple types; and
the predetermined orientation profile is based on the data identifying the inhaler.

15. The apparatus of claim 13, further comprising a handheld control that is coupled to the processor, wherein the set of actions further comprises generating a signal to the at least one output element prompting the user to activate the handheld control at the same time that the user inhales.

16. The apparatus of claim 13, wherein the at least one output element includes a speaker.

17. The apparatus of claim 13, wherein the set of actions further comprises generating a signal to the at least one output element prompting the user to exhale if the set of exhale audio signals does not match the first predetermined audio profile.

18. The apparatus of claim 13, wherein the set of actions further comprises generating a signal to the at least one output element prompting the user to inhale if the set of inhale audio signals does not match the second predetermined audio profile.
